(19) United States
(12) Patent Application Publication
(10) Pub. No.: US 2023/0351548 A1
(43) Pub. Date: Nov. 2, 2023

(54) METHOD FOR CREATING A PICTURE RECORDING

(71) Applicant: K|LENS GMBH, Saarbrucken (DE)

(72) Inventor: Klaus ILLGNER, Starnberg (DE)

(21) Appl. No.: 18/027,794

(22) PCT Filed: Sep. 22, 2021
(86) PCT No.: PCT/EP2021/076016

§ 371 Date: Mar. 22, 2023

(30) Foreign Application Priority Data
Sep. 22, 2020 (LU) LU102084
Sep. 22, 2020 (LU) LU102086

(51) Int. Cl. G06T 3/00; H04N 23/957; H04N 23/55

(52) U.S. Cl. CPC G06T 3/0093; H04N 23/957; H04N 23/55

(57) ABSTRACT

A method for creating a plenoptic picture recording, wherein a plurality of images of an object region, which are simultaneously produced adjacently to each other on a receiver surface by an optical device and are digitally stored, are further processed to form picture captures. A picture correction is automatically carried out, in which at least one of the picture captures is changed in comparison with the associated image. For each of the images a picture correction specific to the image in question is performed, the respective specific picture corrections for the individual images preferably differ from each other. A picture correction that changes the picture capture in comparison with the associated image is automatically carried out so that the picture captures are brought into line with each other.

The invention relates to a method for creating a plenoptic picture recording, in which multiple images of an object area, which are generated simultaneously adjacent to one another on a receiver surface by means of an optical device and are digitally stored, are further processed to form picture recordings.

The invention furthermore relates to a computer program product, to a device for data processing, and to a data carrier signal.

WO 2014/124982 A1 describes a plenoptic camera, which comprises an objective that contains multiple mirrors which form a kaleidoscope. During creation of a picture recording, light beams enter the objective through a main lens group, are put into the kaleidoscope by the main lens group, and are guided onto a sensor after the kaleidoscope by a further lens group. The kaleidoscope is constructed in such a way that the mentioned images, which capture the object area from slightly different viewing angles due to the effect of the kaleidoscope, but nonetheless represent an identical object area, are generated adjacent to one another in a 3×3 grid on the sensor. Thanks to the capture of the images from the different viewing angles, among other things, items of information about the spatial position of points imaged in the images can be obtained from the images.

The invention is based on the object of simplifying the creation of a plenoptic picture recording.

This object is achieved according to the invention in that an image correction takes place automatically during the further processing, in which at least one of the picture recordings is changed in relation to the respective image.

Even a minor deviation from the provided position or shape of components of the optical device can have the result that different imaging areas are undesirably captured in the images or that individual imaging errors, such as distortions or vignetting, occur from image to image.

This applies in particular if the optical device includes, as explained in more detail below, at least one mirror and/or at least one prism and/or comprises a kaleidoscope and thus beam paths are provided in such a way that the images of the object area may be generated simultaneously multiple times on the receiver surface, wherein the various images are preferably arranged adjacent to one another, in particular vertically and/or horizontally adjacent to one another. The various images are preferably each generated as coherent and/or complete images on the receiver surface.

Thanks to the further processing according to the invention it becomes possible to automatically correct individually each of the individual images reproducing the object area multiple times on the receiver surface, in particular completely and adjacent to one another. An image correction specific for the respective image is expediently carried out for each of the images, wherein the respective specific image corrections for the individual images preferably differ from one another.

The image-specific image correction is advantageous because each of the images are generated by means of the optical device via different beam paths adjacent to one another on the receiver surface and the images therefore require separate corrections. Due to the complicated beam paths in the optical device, which can comprise multiple reflections, even minor tolerance-related deviations of the provided arrangements or shapes of individual optical components of the optical device can result in imaging errors, which differ for each of the images and additionally are characteristic for the optical device respectively used. Such imaging errors can have the result that different image areas are undesirably captured in the pictures or that individual imaging errors, such as distortions or vignetting, occur from image to image.

The method according to the invention is carried out by a computer in the preferred embodiment of the invention.

In one embodiment of the invention, during the further processing of at least individual ones of the images, an image correction changing the picture recording in relation to the respective image takes place automatically in such a way that the picture recordings are equalized to one another.

Due to an equalization of the picture recordings formed from the individual images, which relates in particular to the arrangement, the intensity, and/or the color of the pixels in the two dimensions, the picture recordings uniformly reproduce the object area. Uniform items of image information for a plenoptic picture recording can thus be generated comparatively easily from the picture recordings, which in addition to the conventional items of image information in two dimensions perpendicular to the optical axis of the optical device contains items of information about the spatial arrangement and possibly the shape of objects in the object area in the direction parallel to the optical axis. In addition, it becomes possible due to the equalization to use each of the picture recordings to create an image reproduction. It has proven to be particularly advantageous that a transition, which is smooth in the representation, between the picture recordings from the various viewing angles becomes possible in the image reproduction.

It has proven to be particularly advantageous to correct the picture recordings, in particular with equalization, in such a way that
a single one or each of the picture recordings is or are changed so that all of the picture recordings depict the same object area,
positions of the pixels are offset in a single one or each of the picture recordings, in particular for equalization,
intensities of pixels are changed in a single one or each of the picture recordings, in particular to eliminate a distortion or/and vignetting and/or to compensate for intensity losses in the beam path through the optical device,
brightnesses of pixels in individual color channels of an image signal, preferably an RGB signal, are changed in individual or each of the picture recordings, in particular to eliminate a distortion or/and vignetting of the respective picture recording,
colors of pixels in individual color channels of an image signal, preferably an RGB signal, are changed in individual or each of the picture recordings, or/and
one or more double or multiple representations of a point or/and a section of the object area in individual or each of the picture recordings is changed, preferably by offset of one or more partial areas of the recording or the recordings, into only a single representation of the points or sections.

In one embodiment of the invention, the image correction is provided in such a way that in the further processing, the pixels which reproduce the same section of the object area in the different picture captures from the different viewing angles are arranged at pixel positions which are arranged in predefined pixel positions in relation to one another from picture capture to picture capture. The pixel positions are preferably predefined depending on the viewing angle, in particular in consideration of a parallax error resulting from the respective different viewing angle.

In particular, the image correction can be provided in such a way that in the further processing, the pixels which reproduce the same section of the object area have the same intensity and/or color in the different picture captures.

In one embodiment of the invention, the optical device includes at least one mirror, preferably multiple mirrors, and/or at least one prism, preferably multiple prisms, for generating the images on the receiver surface. The mirror or mirrors and/or the prism or the prisms are arranged in the optical device in such a way that multiple images of the object area can be generated on the receiver surface. Diverse different arrangements of mirrors and/or prisms are possible for this purpose in principle. It has proven to be particularly advantageous to provide the optical device in such a way that multiple mirrors are provided and arranged in such a way that the various light beams entering an entry opening, depending on the beam path, penetrate through the optical device without reflection during the passage through the optical device or are reflected on one or more of the mirror surfaces, possibly multiple times, before they leave the optical device again.

In one particularly preferred embodiment of the invention, the optical device comprises a kaleidoscope. Such a kaleidoscope expediently comprises at least one pair of planar mirror surfaces, wherein the mirror surfaces are arranged facing toward one another and at a distance from one another. At least a part, preferably all, of the beam paths extend through the space between the mirror surfaces. Mirror surfaces are preferably arranged parallel to one another. The kaleidoscope can include two or more mirror pairs. A tube can be formed from the mirror pairs, which is polygonal, preferably rectangular, in cross section. The kaleidoscope could alternatively be formed by a cylindrical glass rod, which is polygonal in cross section and has mirrored lateral surfaces and end faces for the entry and exit of the light beams. The glass rod preferably has the shape of an equilateral triangle, a rectangle, in particular square, a regular pentagon, hexagon, heptagon, or octagon in cross section.

The mirrors and/or prisms are expediently provided in such a way that the various images represent the object area recorded from different viewing angles. It thus becomes possible to form a plenoptic camera by means of the optical device.

In one embodiment of the invention, an imaging system is used for the plenoptic picture recording which comprises multiple imaging devices arranged in succession in the direction of an optical axis. A first imaging device generates a real intermediate image of the object area in an intermediate image plane, a second imaging device, which comprises the mentioned optical device, generates at least one virtual mirror image of the real intermediate image, which is arranged offset to the real intermediate image in the intermediate image plane, and a third imaging device generates a common image of the real intermediate image and the virtual mirror image as a real image on an image receiver surface to be arranged at an axial distance to the intermediate image plane.

The image correction expediently takes place on the common image of the real intermediate image and the at least one virtual mirror image as a real image.

The mentioned specific image correction is preferably carried out for the real intermediate image and for the virtual mirror image, particularly preferably for each of the virtual mirror images.

In one particularly preferred embodiment of the invention, the optical device is arranged in an objective which includes at least one lens which preferably forms the first imaging device.

In one preferred embodiment of the invention, at least one light entry lens, preferably multiple light entry lenses forming a light entry lens system, is arranged before the optical device in the beam path direction.

The optical device, which preferably forms the second imaging device, is expediently formed in such a way that the light beams entering the optical device are split in accordance with their direction in such a way that they capture the object area from slightly different viewing angles but nonetheless represent the same object area.

The light entry lens is expediently provided in such a way that it images the object area on an input plane at an end of the optical device facing toward the light entry lens.

In one embodiment of the invention, at least one light exit lens, preferably multiple light exit lenses jointly forming a light exit lens system, is arranged after the optical device as viewed in the beam path direction, by means of which the beam paths are formed in such a way that the images are generated in the manner according to the invention on the receiver surface. The light exit lens or the light exit lenses preferably form the mentioned third imaging device.

The light exit lens system is expediently formed in such a way that its focal plane is identical to the input plane of the optical device, in particular the kaleidoscope.

It is obvious that the arrangement of the lenses and the mirrors or prisms one behind another can result in, possibly complex, image errors in the images, which can be corrected only with difficulty or not at all using conventional image correction methods. Even a minor deviation from the provided position or shape of one of the lenses, the mirrors, or the prisms can have the result that different parts of the object area are undesirably captured in the images or that different imaging errors, such as distortions, occur from image to image.

In one particularly preferred embodiment of the invention, N×N images of the object area are formed on the receiver surface and generated in an N×N grid adjacent to one another, wherein N preferably represents an odd number. The N×N images are expediently formed in such a way that they cover, in particular completely or at least nearly completely, a part of the receiver surface that can be read out. The images are preferably arranged vertically and horizontally adjacent to one another in the grid.

The images are expediently generated in such a way that they image the object area from various viewing angles.

Nine images of the object area, which are generated in a 3×3 grid, are particularly preferably formed on the receiver surface. Alternatively, for example, 25 images of the object area can be generated in a 5×5 grid or 49 images can be generated in a 7×7 grid. It is obvious that to increase the number of the achievable viewing angles, larger numbers of images and corresponding grid arrangements can also be provided.

Embodiments of the optical device, in particular the objective, are described in WO 2014/124982 A1. The content of WO 2014/124982 A1 is incorporated in the present application by reference. Reference is specifically made to the text on page 7, first paragraph to page 11, second paragraph and FIGS. 1 to 3. Suitable optical devices are described therein and their mode of operation is explained.

The objective expediently comprises housing, in which the at least one lens and the optical device are arranged. The objective is preferably provided with a device for mechanical fastening on a camera housing, for example an objective thread or an objective bayonet. Furthermore, it can be provided with a device for electrical or electronic connection and/or for data transfer with the camera housing.

The receiver surface expediently has at least one picture capture sensor or is formed by at least one picture capture sensor. In the preferred embodiment of the invention, the receiver surface is formed by a single picture capture sensor. The picture capture sensor is preferably a CCD sensor or a CMOS sensor.

In one embodiment of the invention, to carry out the image correction, positions of at least individual ones of the pixels and/or intensities and/or colors of at least individual ones of the pixels are changed in at least individual ones of the picture recordings, preferably in each of the picture recordings. The image correction preferably takes place automatically by means of a computer program.

In one embodiment of the invention, the image correction takes place in such a way that the positions, the intensities, and/or the colors of the pixels are changed in such a way that the pixels respectively imaging in the same section of the object area are arranged in the same position in the various recordings and/or have the same intensity and/or the same color.

In one particularly preferred embodiment of the invention, the pixels are changed with application of pixel correction rules provided for each of the images, wherein preferably the pixel positions are changed with application of pixel arrangement rules provided for each of the picture captures, which can comprise at least one pixel offset, and/or the intensities and/or the colors of the pixels are changed with application of pixel intensity and/or pixel color change rules provided for each of the picture captures. The image correction rules for the individual images expediently differ from one another. Advantageously, the individual images can therefore be corrected separately and individually for the captures from the various viewing angles.

In one embodiment of the invention, the image correction rules, in particular the pixel arrangement rules and/or the pixel intensity and/or pixel color change rules, are determined by a method for determining image correction rules, in which, from a picture recording of at least one reference object, the pixels and/or the acquired intensities and/or colors in each of the picture captures are expediently compared to respective reference image positions and/or reference intensities and/or colors, using which the reference object is to be formed for the correct representation of the recorded area. The image correction rules, in particular the pixel arrangement rules and/or pixel intensity change and/or pixel color change rules are determined, preferably by determining the differences of the positions, the intensities, and/or the colors of the picture recordings from the reference image positions and/or reference intensities and/or colors.

The image correction rules are respectively expediently determined separately in each case for the mentioned real intermediate image and in each case for the at least one virtual mirror image or each of the virtual mirror images.

In one embodiment of the invention, the reference object is displayed by means of a display means, preferably a display screen or a projector. Reference objects having different properties can advantageously be used for calibration in a particularly simple manner. In addition, it becomes possible to create the image correction rules easily and quickly on the basis of at least two different reference objects. A large number of reference objects could be displayed, possibly at short time intervals in succession. It would furthermore be conceivable to provide a reference object video in which the various reference objects are displayed in succession.

It is obvious that for each of the reference objects displayed by means of the display means, reference image positions and/or reference intensities and/or colors, using which the reference object is to be formed for correct representation of the recorded area, are provided as described above. A reference video corresponding to the reference object video could be provided, which shows the respective reference image positions and/or reference intensities and/or colors.

It is obvious that the method for determining image correction rules, which can be a method executed on a computer, can be carried out independently of the method for creating a plenoptic picture recording. It represents an independent invention.

The reference object, which is arranged during the picture capture in a reference position in relation to the optical device, is expediently illuminated using a reference illumination and/or has a reference color for determining the correction rules.

It has proven to be particularly advantageous to provide a reference pattern formed in a plane as the reference object, wherein the plane is arranged perpendicular to the optical axis and/or parallel to the sensor plane in front of the optical device. The reference pattern expediently comprises lines or surfaces which have linear edges. The reference pattern is preferably formed by multiple straight lines, which are arranged like a grid parallel and/or perpendicular to one another. Alternatively or additionally thereto, for example, a chessboard pattern or at least one other regular formation or structure, which enables a comparison of the items of information from the various images and a determination of the pixel arrangement rules and/or the pixel intensity and/or pixel color change rules, could as the pattern.

In one embodiment of the invention, the image correction is provided in such a way that during the further processing, the pixels which reproduce the same section of the reference pattern are arranged at the same point in the various picture captures. In one embodiment of the invention, image correction rules which relate to pixel areas which are not located directly in the reference pattern are generated, for example by interpolation.

Image correction rules, in particular the pixel replacement rules and/or the pixel intensity and/or pixel color change rules, are expediently stored, preferably as a data set for use in a computer program for carrying out the image correction. The data set can comprise metadata for a plenoptic picture recording generated by means of the optical device. It is expediently provided together with the optical device, in particular the objective, for example as a file on a data storage medium, which can be physically connected to the optical device, or as a signal sequence retrievable via a computer network, for example the Internet, and representing the data set. It would be conceivable to provide a link to a file stored in the computer network, in particular the Internet, on the optical device, for example on the housing of the objective. The link could be, for example, a QR link or the like.

Furthermore, the image correction rules, in particular the pixel arrangement rules and/or the pixel intensity and/or pixel color change rules, can differ from one another depending on the focus setting of the optical device. At least two, preferably multiple image recordings of at least one reference object are expediently generated in different focal planes arranged at a distance from one another for their determination.

For focus settings which are outside this focal plane, the pixel arrangement rules and/or the pixel intensity and/or pixel color change rules can be determined from the rules which have been determined by means of the image recordings in the focal planes, for example by interpolation.

If the optical device, in particular the objective, as provided according to one embodiment of the invention, is configured for adjusting its focal plane, the image correction is preferably carried out depending on the setting of the focal plane of the optical device.

The offset is expediently determined specifically only for individual points in the picture captures and the respectively required offset in the areas between the points is determined by interpolation.

In an analogous manner, the required change of the intensity and/or the color can also only be determined for individual points and the respectively required intensity or color change in the areas between the points can be determined by interpolation.

The invention proves to be particularly advantageous since by means of the method optical devices, in particular objectives, of the above-mentioned type can be prepared easily for use, even if they are produced in mass production and have tolerance-related differences in the arrangement and shape of their respective optical elements such as the lenses, mirrors, prisms, and the like. The method can thus be carried out within a process for preparing the optical device for release to a user and the items of information obtained in this case, in particular the image correction rules, can be stored in a data set for use by means of a computer program, which is issued together with the optical device. The image correction rules are expediently determined individually for each optical device, in particular each objective.

In one embodiment of the invention, to generate the plenoptic picture recording, items of information determined by means of the receiver surface, in particular the sensor, on the images are stored together with the data set, wherein the data set can is be present as metadata. The plenoptic picture recordings can subsequently be generated by means of a computer program, which further processes the items of image information by means of the image correction rules stored in the data set and the performance of the image correction.

The invention furthermore relates to a computer program product, comprising commands, which, upon the execution of the program by a computer, prompt it to carry out at least individual steps of the above-explained method.

In particular, the computer program product comprises commands which, upon the execution of the program by a computer, prompt it the steps of a method for creating a plenoptic picture recording, in which multiple images of an object area, which are generated simultaneously adjacent to one another on a receiver surface by means of an optical device and are digitally stored, are further processed to form picture captures, wherein an image correction is carried out automatically during the further processing, in which at least one of the picture captures is changed in relation to the respective image.

The computer program product can expediently be loaded directly into the internal memory of a digital computer, in particular a computer of a device for creating a picture recording, and comprises software sections that carry out the method steps when the computer program product runs on the computer.

The computer program product is expediently a computer program stored on a data carrier, preferably RAM, ROM, CD, or the like, or a device, in particular a personal computer, a smart phone, a computer of a device for creating a picture recording, in particular a photo and/or video camera, or a signal sequence representing data suitable for transmission via a computer network, in particular the Internet.

The invention furthermore relates to a device for data processing, which comprises means for carrying out the method.

In one embodiment of the invention, the device is part of an optical device which is configured for simultaneously generating multiple images of an object area adjacent to one another on a receiver surface, wherein the optical device preferably comprises a kaleidoscope.

The device is expediently part of a camera, in particular a photo and/or video camera.

In one particularly preferred embodiment of the invention, the data processing device is provided for operating the camera, in particular photo and/or video camera, during the creation of a picture recording by means of the camera.

The data processing device is expediently part of the optical device, in particular the camera, and is formed therein, for example, by a processor and a memory which the processor can access.

The invention furthermore relates to a camera, in particular photo and/or video camera, which comprises the mentioned data processing device. The camera expediently includes the mentioned optical device and the mentioned receiver surface and is suitable for generating the nine optical picture recordings. In one embodiment of the invention, the camera comprises the mentioned objective, in which the optical device is arranged.

The invention furthermore relates to a data set of image correction rules, which for use in a method for creating a plenoptic picture recording, in which multiple images of an object area are generated simultaneously adjacent to one another on a receiver surface by means of an optical device and the images are further processed to form picture captures, which have pixels, wherein during the further processing of the images, an image correction is carried out with automatic application of the image correction rules, in which at least one of the picture captures is changed in relation to the respective image.

The invention is explained in more detail hereinafter on the basis of exemplary embodiments and the appended drawings, which relate to the exemplary embodiments. In the figures:

FIG. 1 shows an optical device for the picture recording according to the invention,

FIG. 2 shows a beam path in the optical device according to FIG. 1,

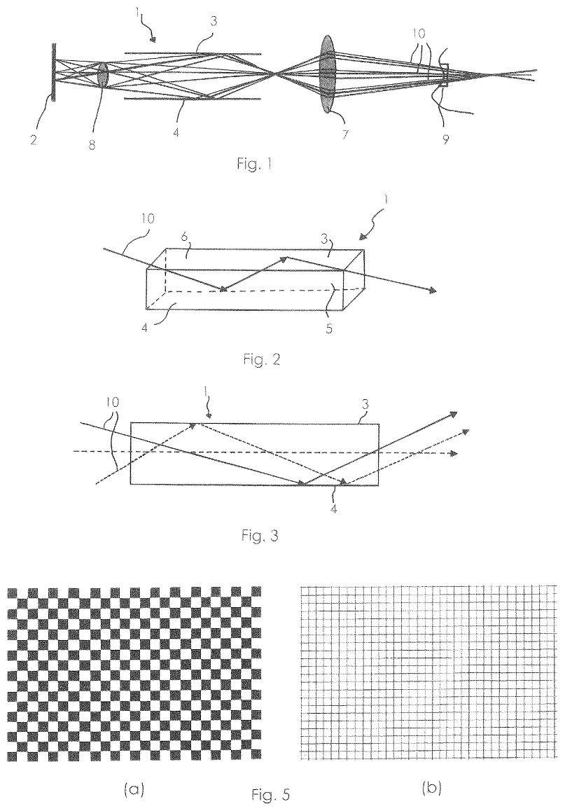

FIG. 3 shows further beam paths in the optical device according to FIG. 1,

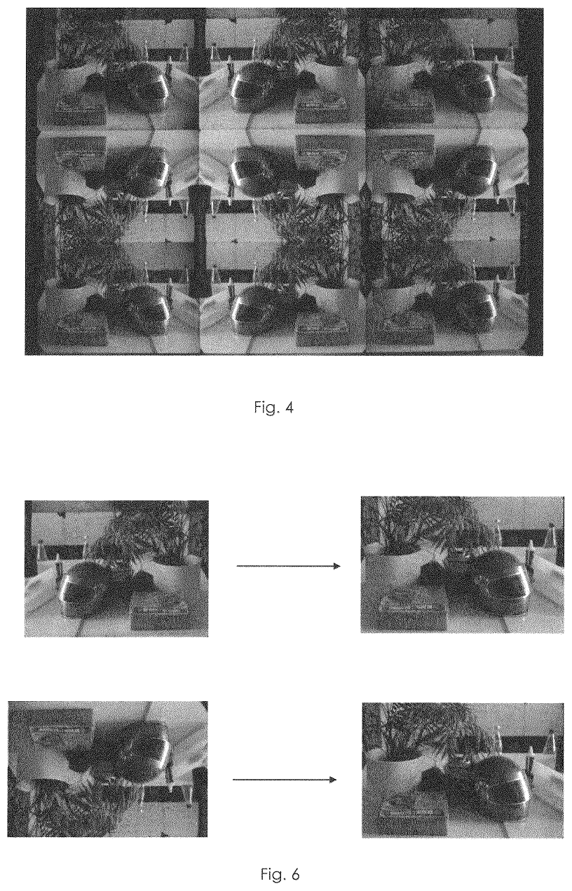

FIG. 4 shows an image captured using a receiver surface,

FIG. 5 shows various reference patterns for use in a method according to the invention,

FIG. 6 shows various picture recordings captured using the optical device before and after the image correction,

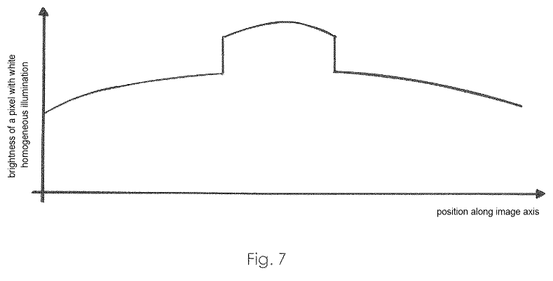

FIG. 7 shows captured intensities along an image axis,

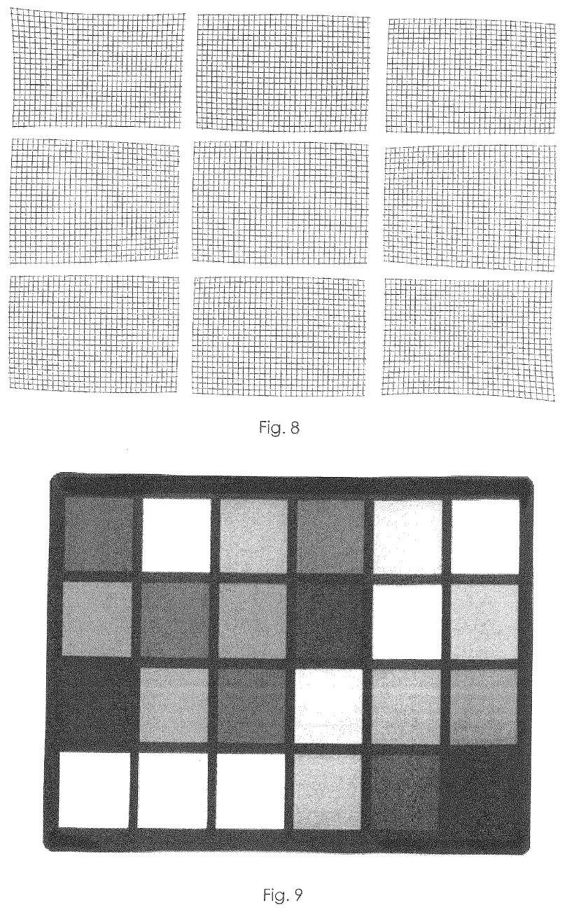

FIG. 8 shows a reproduction of images of a reference pattern, and

FIG. 9 shows a further reference pattern for use in a method according to the invention.

FIG. 1 schematically shows how a plenoptic picture recording is created in a manner according to the invention using an optical device 1 which, in addition to an entry lens 7 and an exit lens 8, includes a mirror box having mirrors 3, 4, 5, 6, which forms a kaleidoscope. The mirrors 3, 4, 5, 6 are arranged in a rectangle in cross section in the mirror box, as FIG. 2 shows, wherein the mirrors surfaces of the mirrors are arranged on the mirror box inside. Light beams 10, which originate from an object area 9 that images an object, enter the entry lens 7 and are deflected by the entry lens into the interior of a mirror box. Some of the light beams 10 reach the exit lens 8 through the mirror box, without striking one of the mirrors 3, 4, 5, 6, other light beams are only reflected one time on one of the mirrors 3, 4, 5, 6 before they strike the exit lens 8. Further light beams in turn are reflected multiple times within the mirror box on the mirrors 3, 4, 5, 6, wherein the reflection can take place both on opposing mirrors and on mirrors 3, 4, 5, 6 arranged adjacent to one another. The exit lens 8 is arranged in such a way that the light beams exiting from the mirror box are guided onto the receiver surface 2, which is formed by a sensor, in particular a CCD or CMOS sensor.

The entry lens 7, the mirrors 3, 4, 5, 6, and the exit lens 8 are arranged in such a way that nine images of the object area are formed on the receiver surface 2, which are generated in a 3×3 grid adjacent to one another. The images are generated in such a way that they form the object area originating from the entry lens 7 from nine different viewing angles. In particular, complete and coherent images of the object area are generated in each case on the receiver surface 2.

Alternatively, the entry lens 7, the mirrors 3, 4, 5, 6, and the exit lens 8 could be arranged in such a way that N×N images of the object area are formed on the receiver surface and are generated in an N×N grid adjacent to one another, wherein N represents an odd number. In addition to the above-mentioned grid, for example, images of the object area in a 5×5 grid or 49 images in a 7×7 grid come into consideration. It is obvious that to increase the number of the achievable viewing angles, larger numbers of images and corresponding grid arrangements can also be is provided.

FIG. 4 shows by way of example images of an object area in the form as they are captured in a capture using the optical device 1 on the receiver surface 2. The images are incident as explained above in a 3×3 grid on the receiver surface 2. However, the individual images represent the object area differently, for example due to distortions, differences in the intensity of the individual pixels corresponding to one another, and the coloration (not reproduced here).

The different representations result, on the one hand, from the capture from the mentioned different viewing angles. In addition, imaging errors and intensity differences result due to the arrangement of the mirrors and the quite complicated beam paths resulting therefrom.

Such intensity differences result inter alia because the light beams pass through different areas of the lens systems depending on perspective. As a result, specific vignetting and/or distortion properties of the lens groups affect the individual images in different strengths. This is clearly apparent in the brightness distribution shown by way of example in FIG. 7. The brightness damping as a result of the reflection is also recognizable here.

Since to create a plenoptic picture recording, in particular to obtain the information about the distance of objects in the object area from the optical device 1 it is necessary for the individual pixels in the conventional two-dimensional representation to be congruent, an image correction of the picture captures is necessary. In particular, the positions of the pixels and/or their intensity and/or color can be changed in such a way that they match with one another. One advantage of the adaptation is that the possibility is also provided of changing the viewing angle within the plenoptic recording, without optical irregularities appearing.

To establish how a corresponding image correction can be performed, a reference pattern is arranged perpendicular to the optical axis and parallel to the plane in which the receiver surface is arranged and a capture of the items of image information on receiver surface 2 is created. Suitable reference patterns are shown by way of example in FIG. 5.

On the basis of the picture capture and a reference pattern, possibly a reference recording, which optimally reproduces the reference pattern, differences of the positions of the pixels of the picture capture acquired using the capture from the positions in which the pixels would have to be arranged upon correct representation may be determined and pixel arrangement rules may be determined therefrom. For areas which are located between the pixels directly determinable by means of the reference patterns, the pixel arrangement rules may be determined, for example, by interpolation.

One example of a recording of the items of imaging information of the reference pattern according to FIG. 5 b) is shown in FIG. 8. Imaging errors are clearly recognizable therein.

In the determination of the pixel arrangement rules, it is determined at which point in the picture capture the respective pixel generated in the image is to be arranged to form a correct picture capture and preceding therefrom an arrangement rule, which can comprise an offset of the pixel, is created. It is obvious that an arrangement rule is provided for each of the pixels.

To correct the intensity of the pixels, sample values are determined from the image field of a uniformly illuminated white object. The correction values for each individual pixel are calculated by a suitable interpolation from the determined correction sample values. FIG. 7 shows by way of example an intensity distribution from which a typical intensity reduction as a result of a multiple reflection is apparent. For the correction, intensity values are determined from the image field of a homogeneously illuminated white object. The correction values for each individual pixel are calculated by a suitable interpolation from the determined correction sample values.

A light wavelength-dependent intensity variation, which can occur, for example, due to irregularities of the coating of the mirror surfaces, is optionally corrected by a wavelength-dependent change of the respective intensities. It can be provided that the intensities are changed depending on color, preferably depending on the color channel, in particular on the RGB color channel. The intensity is particularly preferably corrected individually for each color, in particular for each color channel.

To be able to correct the colors of the individual pixels, at least one color reference pattern is captured which includes a large number of colors, or multiple captures of various monochromatic color reference patterns are captured. A color reference pattern having a large number of colors is shown in FIG. 9—only in black-and-white here. It has multiple rectangular surfaces of different coloration.

Differences of the colors of the pixels of the picture capture acquired with the capture from the colors in which the pixels would have to have upon correct representation may be determined on the basis of the picture capture and a color reference recording, which optimally reproduces the color reference pattern, and pixel color change rules may be determined therefrom. For areas which are located between the pixels directly determinable by means of the reference patterns, the pixel color change rules may be determined, for example, by interpolation.

In FIG. 6, the images in the upper image line in the middle and the middle image line on the right from the 3×3 grid from FIG. 4 are shown individually before and after the image correction.

1-15. (canceled)

16. A method for creating a plenoptic picture recording, comprising the steps of: simultaneously generating multiple images of an object area adjacent to one another on a receiver surface by an optical device; digitally storing the multiple images; and further processing the multiple images to form picture captures, the further processing including automatically carrying out an image correction in which at least one of the picture captures is changed in relation to a respective image.

17. The method according to claim 16, including carrying out for each of the images an image correction specific for the respective image, wherein the respective specific image corrections for the individual images differ from one another.

18. The method according to claim 16, wherein during the further processing of at least individual ones of the images, an image correction changing the picture capture in relation to the respective image takes place automatically so that the picture captures are equalized to one another.

19. The method according to claim 16, wherein the image correction, in at least individual ones of the picture captures includes changing positions of at least individual pixels and/or intensities of a representation of at least individual ones of the pixels.

20. The method according to claim 19, including changing the pixel positions by application of pixel arrangement rules provided for each of the picture captures and/or changing the intensities and/or colors of the representation of the pixels with application of pixel intensity and/or pixel color change rules provided for each of the picture captures, wherein the pixel arrangement rules and/or the pixel intensity and/or pixel color change rules for the individual picture captures differ from one another.

21. The method according to claim 20, wherein the pixel arrangement rules and/or the pixel intensity and/or pixel color change rules are determined in a calibration method, in which a picture capture of a reference object, which is arranged in a reference position in relation to the optical device, is illuminated using a reference illumination, and/or has a reference coloration, is created and the pixels and/or the acquired intensities and/or colors in each of the picture captures are compared to respective reference imaging positions and/or reference intensities and/or colors, using which the reference object is imaged for correct representation of the captured area, wherein the pixel arrangement rules and/or the pixel intensity change rules are determined by determining differences of the positions, the intensities, and/or the colors of the picture recordings from the reference imaging positions and/or reference intensities and/or colors.

22. The method according to claim 20, wherein the image correction is carried out so that the positions, the intensities, and/or the colors of the pixels are changed so that the pixels respectively imaging the same section of the object area are arranged in the various picture captures in the same position and/or in positions resulting depending on the viewing angle, in particular in consideration of a parallax error resulting from the respective different viewing angle, and/or have the same intensity and/or the same color as in the reference position.

23. The method according to claim 16, including generating the picture recording by an imaging system that includes the optical device, wherein the imaging system comprises multiple imaging devices arranged in succession in a direction of an optical axis, wherein the imaging devices include a first imaging device that generates a real intermediate image of the object area in an intermediate image plane, a second imaging device, which comprises the optical device, that generates at least one virtual mirror image of the real intermediate image, which is arranged in the intermediate image plane offset to the real intermediate image, and a third imaging device that generates a common image of the real intermediate image and the virtual mirror image as a real image on an image receiver surface arranged at an axial distance to the intermediate image plane.

24. The method according to claim 16, including forming N×N images of the object area on the receiver surface in an N×N grid.

25. A computer program product, comprising commands which, upon execution of the program by a computer, prompt the computer to carry out the method according to claim 16.

26. The computer program product according to claim 25, wherein the computer program product is a computer program stored on one of the group consisting of: a data carrier; a personal computer; a smart phone; a computer of a device for creating a picture recording; or is a signal sequence suitable for transmission via a computer network and representing data.

27. A device for data processing, comprising means for carrying out the method according to claim 16.

28. The device according to claim 27, wherein the device is part of an optical device that is configured for simultaneously generating multiple images of an object area adjacent to one another on a receiver surface.

29. The device according to claim 28, wherein the optical device comprises a kaleidoscope.

30. The device according to claim 27, wherein the device is part of a camera.

31. A data carrier signal, which transmits the computer program product according to claim 25.
